(19) United States
(12) Patent Application Publication
(10) Pub. No.: US 2026/0023964 A1
(43) Pub. Date: Jan. 22, 2026

(54) OPTICAL CALCULATION DEVICE AND OPTICAL CALCULATION PROCESSING SYSTEM

(71) Applicant: SONY GROUP CORPORATION, TOKYO (JP)

(72) Inventor: KOHEI YAMAMOTO, TOKYO (JP)

(21) Appl. No.: 18/997,091

(22) PCT Filed: Jan. 30, 2023
(86) PCT No.: PCT/JP2023/002797

§ 371 Date: Jan. 19, 2025

(30) Foreign Application Priority Data
Jul. 26, 2022 (JP) 2022-119067

(51) Int. Cl. G06N 3/067; G02B 26/08; G06N 3/045

(52) U.S. Cl. CPC G06N 3/067; G02B 26/0833; G06N 3/045

(57) ABSTRACT

An optical calculation device according to one embodiment of the present disclosure includes an optical neural network unit, a photodetection unit, and an output unit. The optical neural network unit is configured by hardware to output a feature amount map as an intensity distribution by encoding entering light. The photodetection unit generates image data by photodetecting the feature amount map. The output unit outputs the image data to an external communication network.

### TECHNICAL FIELD

The present disclosure relates to an optical calculation system and an optical calculation processing system.

### BACKGROUND ART

In recent years, there are increasing attentions to technologies to reduce communication capacity, by only transmitting metadata or feature amount similar thereto extracted by neural network.

### CITATION LIST

### Patent Literature

Patent Literature 1: Japanese Unexamined Patent Application Publication No. 2019-191635

### SUMMARY OF THE INVENTION

However, the extraction of feature amount by neural network has problems, such as high calculation cost and high power consumption on an edge device. Therefore, it is desirable to provide an optical calculation device, which allows suppression of calculation cost and energy consumption, and also to provide an optical calculation processing system provided therewith.

An optical calculation device according to a first aspect of a present disclosure is provided an optical neural network unit, a photodetection unit, and an output unit. The optical neural network unit is configured by hardware to output a feature amount map as an intensity distribution by encoding entering light. The photodetection unit generates image data by photodetecting the feature amount map. The output unit outputs the image data to an external communication network.

An optical calculation processing system according to a second aspect of the present disclosure is provided with an optical calculation device and an information processing device, communicatable with each other via a communication network. The optical calculation device is provided with an optical neural network unit, a photodetection unit, and an output unit. The optical neural network unit is configured by hardware to output a feature amount map as an intensity distribution by encoding entering light. The photodetection unit generates image data by photodetecting the feature amount map. The output unit outputs the image data to the information processing device via the communication network. The information processing device includes a processing unit that processes the image data acquired from the optical calculation device via the communication network.

According to the optical calculation device of to the first aspect of the present disclosure and the optical calculation processing system of the second aspect of the present disclosure, the optical neural network unit encodes entering light to generate the feature amount map, and the image data is generated by photodetecting the feature amount map in the photodetection unit. Thus, since the feature amount map is generated by the optical neural network unit before acquiring the image data in the photodetection unit, it is possible to perform information compression with low calculation cost and low power consumption.

### BRIEF DESCRIPTION OF THE DRAWINGS

FIG. 1 is a diagram illustrating an overall configuration example of an optical calculation device and an optical calculation processing system provided therewith according to an embodiment of the present disclosure.

FIG. 2 is a diagram illustrating a configuration example of a hardware of an optical neural network of FIG. 1.

FIG. 3 is a diagram illustrating a modification example of the optical calculation processing system of FIG. 1.

FIG. 4 is a diagram illustrating a modification example of the optical calculation processing system of FIG. 1.

FIG. 5 is a diagram illustrating a modification example of the optical calculation processing system of FIG. 1.

FIG. 6 is a diagram illustrating a modification example of the optical calculation processing system of FIG. 1.

FIG. 7 is a diagram illustrating a modification example of the optical calculation processing system of FIG. 1.

FIG. 8 is a diagram illustrating a modification example of the optical calculation device of FIG. 1 and FIG. 3 to FIG. 7.

FIG. 9 is a diagram illustrating a modification example of the optical calculation device of FIG. 1 and FIG. 3 to FIG. 7.

FIG. 10 is a diagram illustrating a modification example of the optical calculation device of FIG. 8.

FIG. 11 is a diagram illustrating a configuration example of a hardware of an optical neural network of FIG. 9 and FIG. 10.

FIG. 12 is a diagram illustrating an overall configuration example of an information processing device in an optical calculation processing system including the optical neural network of FIG. 9 and FIG. 10.

FIG. 13 is a diagram illustrating an overall configuration example of an optical calculation processing system including the optical calculation device of FIG. 9 or FIG. 10.

FIG. 14 is a diagram illustrating a modification example of an overall configuration of the optical calculation processing system of FIG. 13.

FIG. 15 is a diagram illustrating an overall configuration example of the calculation device of FIG. 13 and FIG. 14.

FIG. 16 is a diagram illustrating a modification example of an overall configuration of the calculation device of FIG. 15.

FIG. 17 is a block diagram depicting an example of schematic configuration of a vehicle control system.

FIG. 18 is a diagram of assistance in explaining an example of installation positions of an outside-vehicle information detecting section and an imaging section.

### MODES FOR CARRYING OUT THE INVENTION

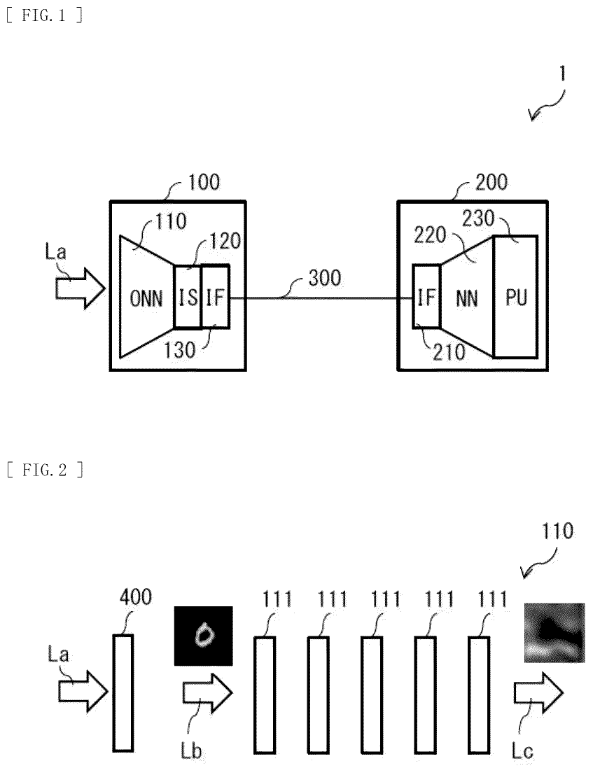

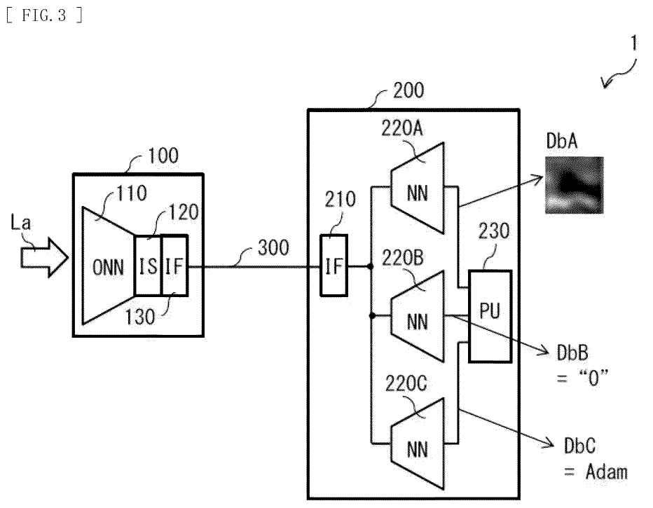

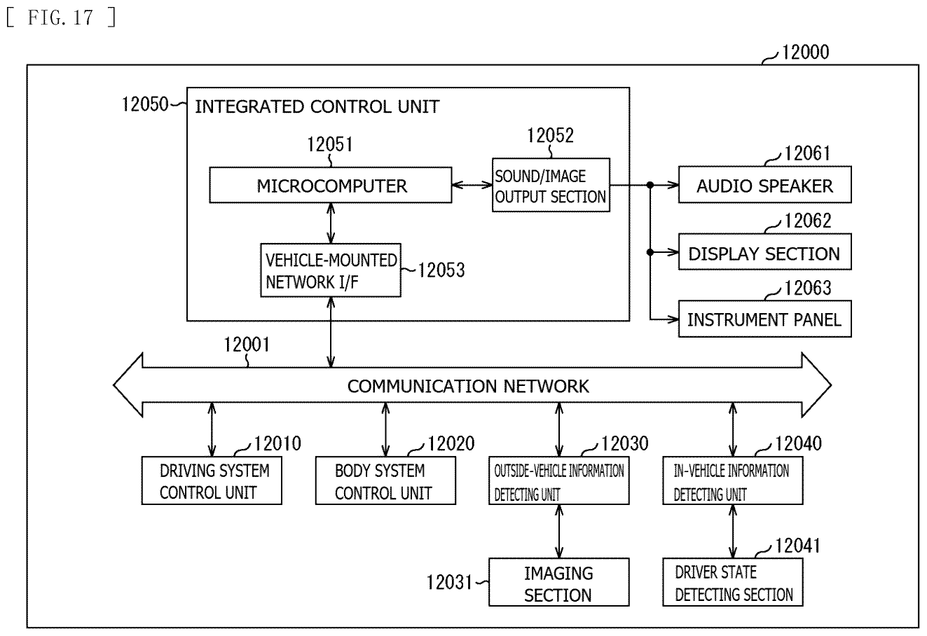

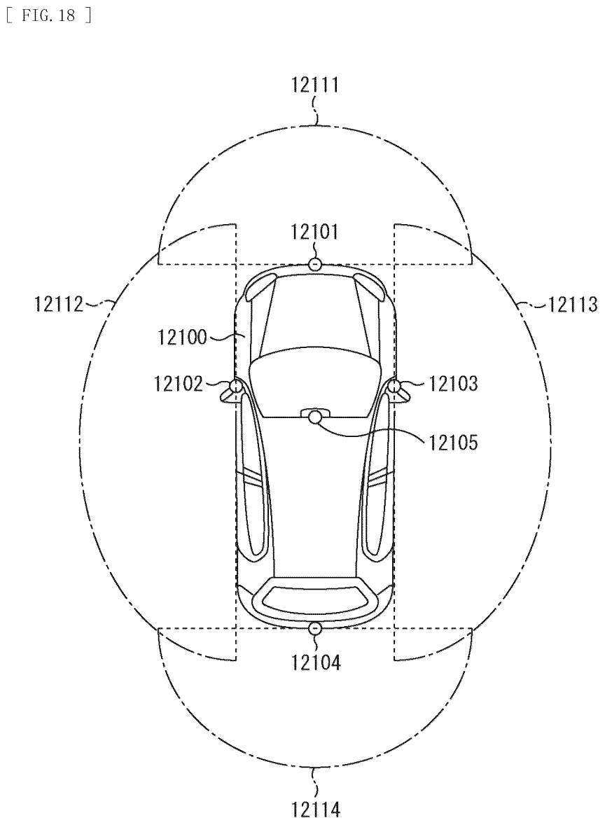

Hereinafter, an embodiment for practicing the present disclosure is described in detail with reference to the drawings. It is to be noted that description is given in the following order.
1. Embodiment (FIG. 1 and FIG. 2)
2. Modification Examples (FIG. 3 to FIG. 16)
3. Application Example (FIG. 17 and FIG. 18)

### 1. Embodiment

### [Configuration]

FIG. 1 illustrates an overall configuration example of an optical calculation processing system 1 according to an embodiment of the present disclosure. The optical calculation processing system 1 is a low-communication-capacity type system, in which an optical neural network unit 110 and a neural network unit 220 are coupled with each other via a communication network 300. The optical calculation processing system 1 is provided with an optical calculation device 100 and an information processing device 200. The optical calculation device 100 and the information processing device 200 are configured to allow communication with each other via the communication network 300.

The optical calculation device 100 includes the optical neural network unit 110, an image sensor 120, and an interface unit 130 (an output unit). The information processing device 200 includes an interface unit 210, a neural network unit 220, and a calculation unit 230. The interface units 130, 210 are configured by interfaces allowing communication with each other via the communication network 300. Any communication network may be used arbitrarily as the communication network 300, for example, a PAN (personal area network) such as USB, Blue Tooth (registered trademark), or a LAN (local area network) such as Ethernet (registered trademark), IEEE 802.11, or a WAN (wide area network).

The optical neural network 110 is provided at a front stage of the image sensor 120. The optical neural network 110 is configured by hardware, which outputs a feature amount map Lc as a light intensity distribution, corresponding to optical characteristics of a plurality of modulation elements 111, by encoding light inputted from an outside (for example, entering light La, or input image light Lb, which will be described afterwards) by a plurality of the modulation elements 111 (optical modulation).

Here, the “hardware” described above is configured, for example as illustrated in FIG. 2, by a plurality of the modulation elements 111 disposed in a row via predetermined intervals. The modulation element 111 will be explained in details afterwards.

Among the entering light La entering from the outside, the input image light Lb is, for example as illustrated in FIG. 2, light transmitted through an aperture 400 (transmitted light). The aperture 400 has an opening pattern, by which the transmitted light (input image light Lb) becomes light representing a numeral “0,” for example as illustrated in FIG. 2. Note that, the aperture 400 is provided expediently in order to acquire the light representing the numeral “0” as the input image light Lb, for example as illustrated in FIG. 2, and is an arbitral component in the optical calculation processing system 1.

The image sensor 120 generates image data Da by photodetecting the feature amount map Lc outputted from the optical neural network unit 110. The image sensor 120 is a solid state imaging element, for example, CCD (charge coupled device), CMOS (complementary metal oxide semiconductor), etc. The interface unit 130 outputs the image data Da, which has been generated in the image sensor 120, to the information processing device 200 via the communication network 300.

The interface unit 130 outputs the image data Da, which has been generated in the image sensor 120, to the information processing device 200 via the communication network 300. The interface unit 210 acquires the image data Da from the optical calculation device 100 via the communication network 300. The information processing device 200 processes the image data Da, which was acquired from the optical calculation device 100 via the communication network 300.

The neural network unit 220 is a calculation device coupled with the optical neural network unit 110, for example, via the image sensor 120, the interface unit 130, the communication network 300, and the interface unit 210. This calculation device is mounted with a neural network for realizing functions of the neural network unit 220. The neural network unit 220 generates a reconstructed image data Db corresponding to the entering light La or the input image light Lb, for example by decoding the image data Da acquired from the optical calculation device 100.

The calculation unit 230 is a calculation device for processing the reconstructed image data Db generated in the neural network unit 220. The calculation unit 230 is configured, for example by including a CPU (central processing unit) and a GPU (graphics processing unit). The calculation unit 230 is mounted with software for realizing functions of the calculation unit 230, and the calculation unit 230 realizes the functions of the calculation unit 230 by executing the software.

Next, the modulation element 111 will be explained. Each of the modulation elements 111 is, for example, a phase difference element or a metasurface. A plurality of the modulation elements 111 is formed by a physically mounted encoder acquired by causing learning model software to learn, which will be explained afterwards.

Here, the “learning model software” is a learning model, imitating a neural network, in which the optical neural network unit 110 and the neural network unit 220 are in an end-to-end coupling. In the “learning model software,” a neural network corresponding to the optical neural network unit 110, is mounted on the software as a physical model, which can learn actual optical systems based on physical laws, and specifically, is configured by optical diffraction calculations and phase modulation calculations, for which the learning has been performed by adjustment of phase modulation amounts. In the “learning model software,” a neural network corresponding to the neural network unit 220, realizes functions such as reconstruction and/or classification of images by utilizing a feature map as an input, which has been outputted from the optical calculation device 110 as the image data Da, and the realization may be accomplished as a neural network such as a convolutional neural network or Transformer.

### [Effects]

Next, effects of the optical calculation processing system 1 will be explained.

In recent years, there are increasing attentions to technologies to reduce communication capacity, by only transmitting metadata extracted by neural network, or feature amount similar thereto. However, the extraction of feature amount by neural network has problems, such as a high calculation cost and a high power consumption on an edge device.

Meanwhile, according to the present embodiment, the optical neural network unit 110 encodes the entering light La, whereby the feature amount map Lc is generated, and the image sensor 120 photodetects the feature amount map Lc, whereby the image data Da is generated. Thus, since the optical neural network unit 110 generates the feature amount map Lc before the image sensor 120 acquires the image data Da, it is possible to perform information compression with low calculation cost and low power consumption. Therefore, the calculation cost and the power consumption can be suppressed.

In the present embodiment, the optical neural network unit 110 is configured by a plurality of phase difference elements 111. Thus, it is not necessary to store the image data Da as digital data in a memory, etc., and therefore, not only the suppression of calculation cost and power consumption, but furthermore, there is also an advantageous point from a viewpoint of security and/or privacy protection.

In the present embodiment, the image sensor 120 is used for detecting the feature amount map Lc. Thus, it is possible to convert the feature amount map Lc efficiently, to the image data Da serving as the digital data.

In the present embodiment, the neural network unit 220 is provided in the information processing device 200. Thus, it is possible to generate the reconstructed image data Db corresponding to the entering light La, by decoding the image data Da having a small data capacity. As a result, it is possible to realize data transmission at a low communication capacity.

### 1. Modification Examples

Next, modification examples of the optical calculation processing system 1 according to the embodiment described above, will be explained. In the following examples, common reference signs will be assigned to common components, and explanations of the common components will be omitted in a proper manner.

### Modification Example A

In the above embodiment the information processing device 200 may include, for example as illustrated in FIG. 3, a plurality of neural networks 220 (for example, 220A, 220B, 220C). Note that, in the present modification example, it is also possible to provide, for example, at least two of the neural networks 220A, 220B, 220C.

The neural networks 220A, 220B, 220C are coupled, in parallel with each other, with an output terminal of the interface unit 210. The image data Da is inputted to the neural networks 220A, 220B, 220C. Outputs from the neural networks 220A, 220B, 220C are inputted, for example into the common calculation unit 230.

The neural networks 220A, 220B, 220C are calculation devices coupled with the optical neural network unit 110, for example, via the image sensor 120, the interface unit 130, the communication network 300, and the interface unit 210. The calculation device serving as the neural network 220A is mounted with a neural network for realizing functions of the neural network unit 220A. The calculation device serving as the neural network 220B is mounted with a neural network for realizing functions of the neural network unit 220B. The calculation device serving as the neural network 220C is mounted with a neural network for realizing functions of the neural network unit 220C.

The neural network unit 220A generates a reconstructed image data DbA corresponding to the entering light La or the input image light Lb, for example by decoding the image data Da acquired from the optical calculation device 100. The neural network unit 220B generates a character classification DbB (for example, a numeral “0”) included in the entering light La or the input image light Lb, for example by decoding the image data Da acquired from the optical calculation device 100. The neural network unit 220C generates a character handwriting DbC (for example, a handwriting of Mr. Adam) included in the entering light La or the input image light Lb, for example by decoding the image data Da acquired from the optical calculation device 100.

The calculation unit 230 processes data (for example, the reconstructed image data DbA, the classification DbB, the handwriting DbC) inputted from a plurality of the neural networks 220 (for example, 220A, 220B, 220C).

In the present modification example, a plurality of the neural networks 220 decodes the image data Da acquired from the optical calculation device 100, whereby a plurality of data (for example, the reconstructed image data DbA, the classification DbB, the handwriting DbC) is generated. Thus, it is possible to perform processing by using at least one of the plurality of data in the calculation unit 230.

### Modification Example B

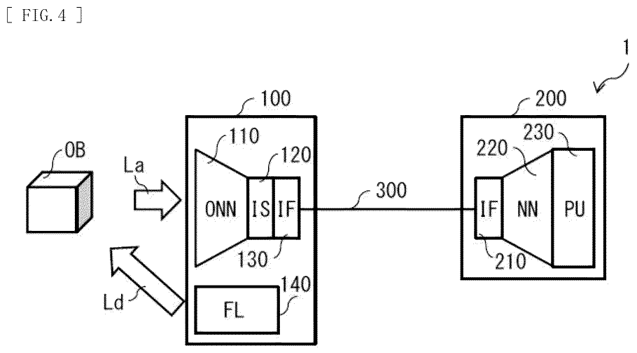

In the above embodiment and the modification example, the optical calculation device 100 may include, for example as illustrated in FIG. 4, a light projection unit 140, which generates irradiation light Ld, and further generates the entering light La by reflected light of the irradiation light Ld. For example, as illustrated in FIG. 4, an object OB is irradiated with the irradiation light Ld, whereby the reflected light is generated from the object OB. This reflected light serves as the entering light La, and enters the optical neural network 110.

The irradiation light Ld may be in a form of, for example, light at a single wavelength, or light including a plurality of wavelengths (for example, light including red light, green light, and blue light; or light including wavelengths covering a whole range of visible region). The irradiation light Ld may be in a form of, for example, monochromatic light, or white light. The irradiation light Ld may be in a form of, for example, spherical wave light, or collimated light. The irradiation light Ld may be in a form of, for example, unpolarized light, or linearly polarized light.

The light projection unit 140 may be in a form of, for example, a point light source, or a light source from which structured light can be outputted. The light projection unit 140 may, for example, output the irradiation light Ld continuously in time, or output the irradiation light Ld intermittently in time (i.e. in a form of pulse).

In the present modification example, the reflected light, generated by irradiation of the irradiation light Ld onto the object OB, serves as the entering light La and enters the optical neural network 110. Thus, it is possible to acquire the image data Da and the reconstructed image data Db corresponding to characteristics of the irradiation light Ld. Consequently, the calculation unit 230 may reconstruct a three-dimensional shape of the object OB based on the reconstructed image data Db. Moreover, the calculation unit 230 may also estimate attitude or orientation of the object OB based on the reconstructed image data Db. Moreover, the calculation unit 230 may also estimate material of the object OB based on the reconstructed image data Db. In a case that the object OB is composed by a plurality of members, respectively made of different materials, the calculation unit 230 may estimate the materials of the object OB at each position of the object OB, based on the reconstructed image data Db.

### Modification Example C

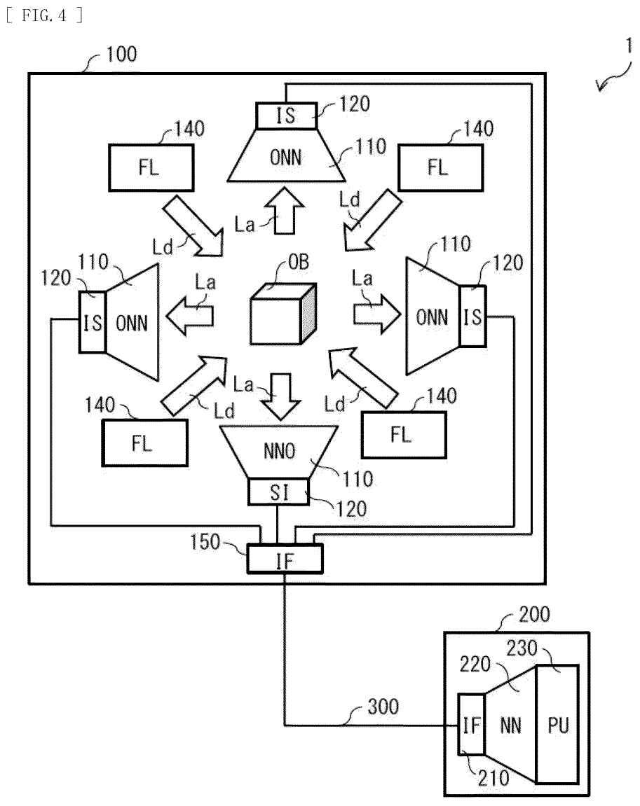

In the above embodiment and the modification example, the optical calculation device 100 may be configured, for example as illustrated in FIG. 5, to generate a plurality of pieces of reflected lights by applying the irradiation light Ld from a plurality of directions onto the object OB.

In this example, the optical calculation device 100 includes, for example as illustrated in FIG. 5, a plurality of light projection units 140, a plurality of optical neural network units 110 provided one by one for each of the pieces of reflected lights, a plurality of image sensors 120 provided one by one for each of the optical neural network units 110, and an interface unit 150. The interface unit 150 outputs a plurality of image data Da, acquired one by one from each of the image sensor 120, to the information processing device 200 via the communication network 300.

In the information processing device 200, the interface unit 210 binds a plurality of the image data Da inputted via the communication network 300, and inputs acquired image data Dc to the neural network 220. The neural network 220 decodes the image data Dc, and accordingly, estimates the three-dimensional shape of the object OB. The calculation unit 230 processes the three-dimensional data of the object OB acquired in the neural network 220.

In the present modification example, a plurality of the image data Da, acquired one by one from each module including the optical neural network unit 110 and the image sensor 120, is outputted to the information processing device 200 via the communication network 300. Thus, based on the image data Dc, it is possible to perform more complicated processing in the information processing device 200.

### Modification Example D

In the above embodiment and the modification example, the optical calculation device 100 may include, for example as illustrated in FIG. 6, an optical-address-type spatial light modulation element 160, and a light source unit 161, which applies coherent light Le onto the optical-address-type spatial light modulation element 160.

The optical-address-type spatial light modulation element 160 is an optical element, composed by material of which optical characteristics change by irradiation of the coherent light Le. As examples of “material of which optical characteristics change” described above, photorefractive material, or photochromic material, may be used.

The optical-address-type spatial light modulation element 160 has a configuration, for example as illustrated in FIG. 6, in which the irradiation of the coherent light Le generates synthetic light (coherent light including phase information), by synthesizing the coherent light Le with incoherent light Lf, which is external light (sunlight or indoor light). This synthetic light serves as the entering light La and enters the optical neural network 110.

In the present modification example, the entering light La is generated by using the optical-address-type spatial light modulation element 160. Thus, it is possible to give nonlinear characteristics to a relation between an optical electric field and a phase, and accordingly, it is possible to generate the reconstructed image data Db accurately, corresponding to the entering light La or the input image light Lb.

### Modification Example E

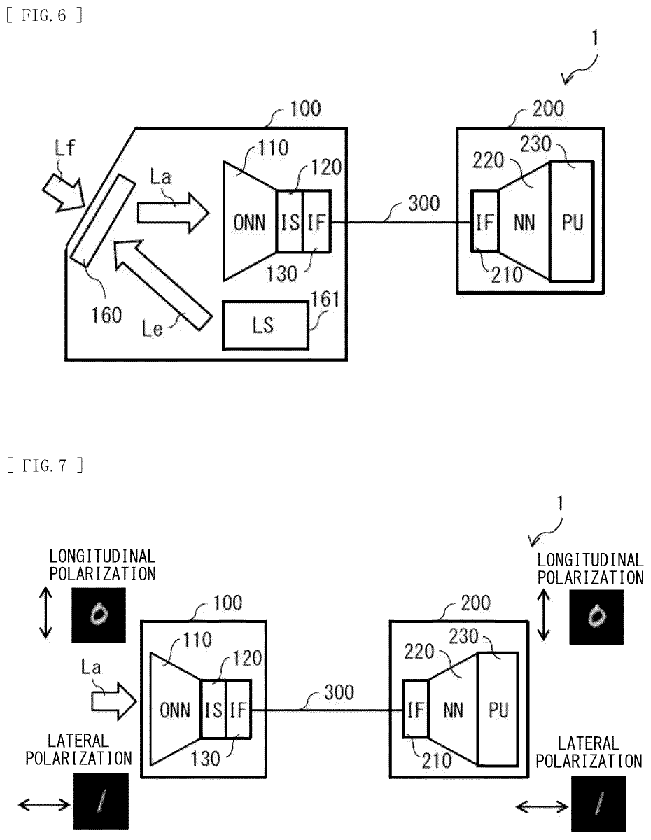

In the above embodiment and the modification example, a plurality of the modulation elements 111 may be formed by birefringent material. In this case, for example as illustrated in FIG. 7, where longitudinally polarized light serving as the entering light La enters the optical neural network 110, the feature amount map Lc and the image data Da corresponding to the longitudinal polarization are generated, and the reconstructed image data Db corresponding to the longitudinal polarization is generated. Moreover, for example as illustrated in FIG. 7, where laterally polarized light serving as the entering light La enters the optical neural network 110, the feature amount map Lc and the image data Da corresponding to the lateral polarization are generated, and the reconstructed image data Db corresponding to the lateral polarization is generated. Therefore, in the present modification example, it is possible to extract information related to polarization, and accordingly it is possible, for example, to perform reconstruction of images under the longitudinal polarization and the lateral polarization, respectively, and/or estimation of surface condition based on a ratio of polarization directions.

### Modification Example F

In the above embodiment and the modification example, the optical calculation device 100 may include, for example as illustrated in FIG. 8, a photodetector array 170 instead of the image sensor 120. In this example, as compared with the image sensor 120, it is possible to increase the reading speed, whereby it is possible to increase the overall driving speed.

### Modification Example G

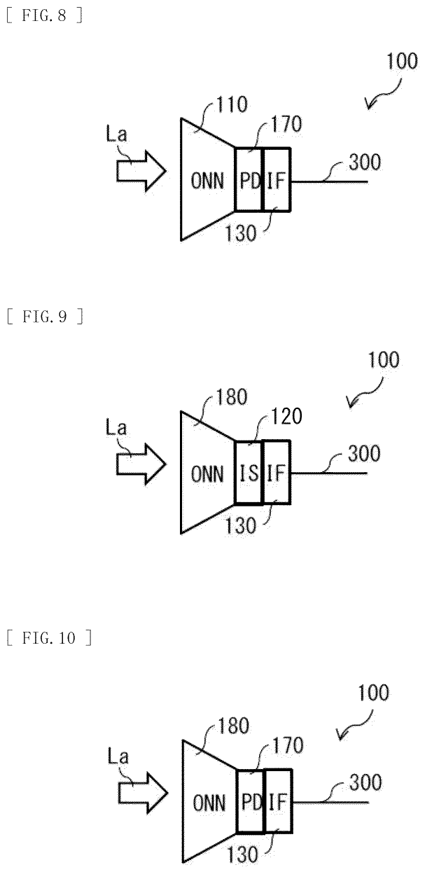

In the above embodiment and the modification example, the optical calculation device 100 may include, for example as illustrated in FIG. 9 and FIG. 10, an optical neural network 180 instead of the optical neural network 110. The optical neural network 180 is provided at a front stage of the image sensor 120 or the photodetector array 170. The optical neural network unit 180 is configured, for example as illustrated in FIG. 11, by hardware, which outputs the feature amount map Lc as a light intensity distribution, corresponding to optical characteristics of a plurality of modulation elements 181, by encoding light inputted from an outside (for example, the entering light La, or the input image light Lb) by a plurality of the modulation elements 181 (optical modulation).

Each of the modulation elements 181 is, for example, a spatial light modulation liquid crystal element or a MEMS mirror. A plurality of the modulation elements 181 is formed by a physically mounted encoder acquired by causing learning model software to learn, which will be explained afterwards.

Here, the “learning model software” is a learning model, imitating a neural network, in which the optical neural network unit 180 and the neural network unit 220 are in an end-to-end coupling. In the “learning model software,” a neural network corresponding to the optical neural network unit 180 includes, for example, an input layer, an intermediate layer, and an output layer. In the “learning model software,” a neural network corresponding to the neural network unit 220 includes, for example, an input layer, an intermediate layer, and an output layer.

Each layer is provided with one neuron or a plurality of neurons. The neurons in the adjacent layers are coupled to each other, and a weight (coupling load) is set to each coupling. The number of couplings of neurons may be set suitably. A threshold has been set for each neuron, and for example, an output value of each neuron is determined in accordance with a result of whether or not the sum of the product of each input value to each neuron and the weight exceeds the threshold.

In the present modification example, the optical calculation device 100 further includes, for example as illustrated in FIG. 11, a drive unit 190 for switching the weight of a plurality of the modulation elements 181. The drive unit 190 switches the weight of a plurality of the modulation elements 181 based on a control signal Dout inputted from the information processing device 200. Thus, every time when the weight of a plurality of the modulation elements 180 is switched, the optical neural network 180 outputs a fresh feature amount map Lc as the light intensity distribution.

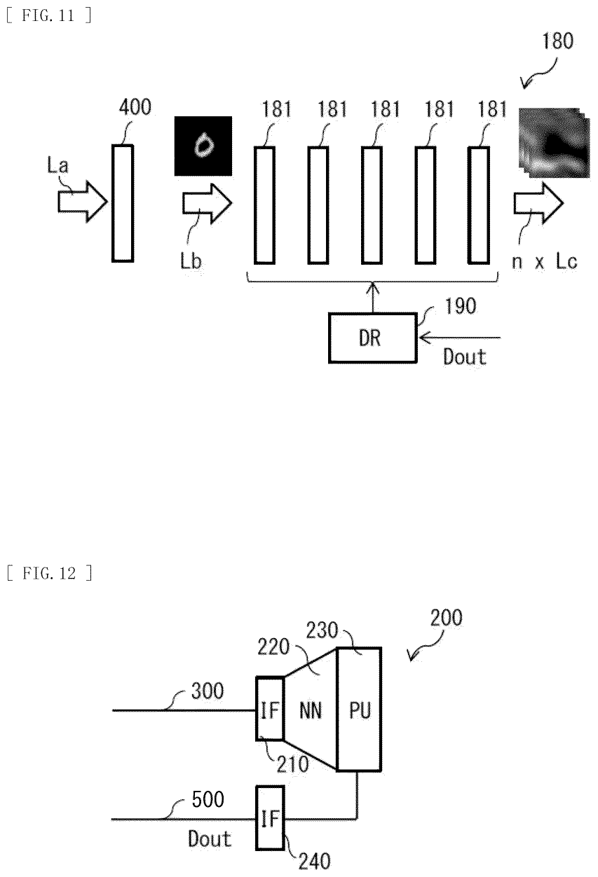

In the present modification example, the information processing device 200 includes, for example as illustrated in FIG. 12, an interface unit 240 for generating the control signal Dout based on the reconstructed image data Db acquired from the calculation unit 230. The interface unit 240 outputs the generated control signal Dout to the optical calculation device 100 via a communication network 500. Note that, the communication network 300 may also serve as the communication network 500, otherwise the communication network 500 may be provided separately from the communication network 300.

In the present modification example, a plurality of the modulation elements 181 is provided, which allows switching of the weight. Thus, it is possible to accomplish high graduation of the reconstructed image data Db. Moreover, it is also possible to cause the optical neural network unit 180 to learn successively based on the output of the neural network unit 220 (decoder), and therefore, it is also possible to generate a highly accurate reconstructed image data Db.

### Modification Example H

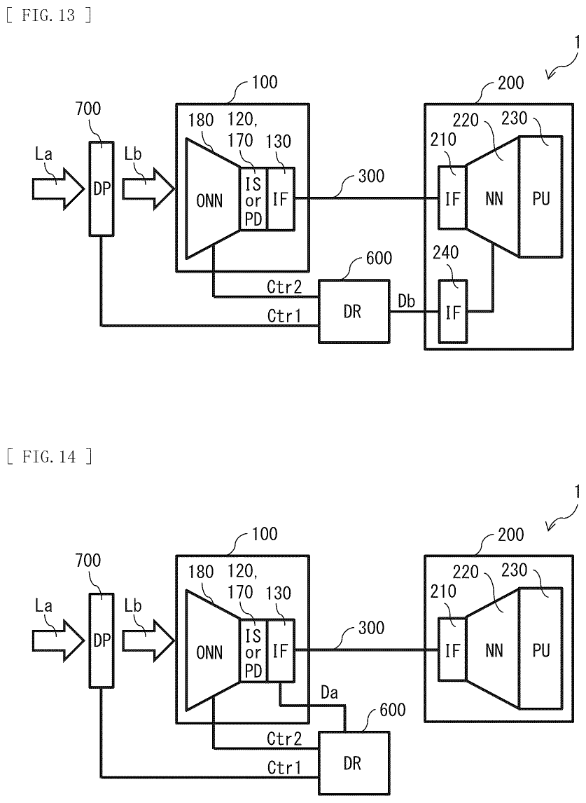

FIG. 13 and FIG. 14 illustrate a modification example of the optical calculation processing system 1 provided with the optical calculation device 100 according to the modification example G described above. In the above modification example G, the optical calculation processing system 1 may include, for example as illustrated in FIG. 13 and FIG. 14, a calculation device 600, and an image display device 700.

The image display device 700 generates various types of image light (input image light Lb), required for machine learning given to the optical neural network 180. The image display device 700 generates, for example various types of image light (input image light Lb), based on a control signal Ctrl inputted from the calculation device 600. The image display device 700 outputs, for example various types of generated image light (input image light Lb), to the optical calculation device 100 (optical neural network unit 180). The image display device 700 is configured, for example by including a liquid crystal display panel or an organic EL display panel.

The calculation device 600 adjusts, by machine learning, a phase amount (weight) of each of the modulation elements 181 included in the optical neural network 180. With the adjustment of the phase amount by the calculation device 600, for example, it is possible to perform highly accurate image reconstruction in the neural network unit 220 (or 220A), it is possible to perform highly accurate classification of characters in the neural network unit 220B, and/or it is possible to perform highly accurate determination of handwritings in the neural network unit 220C.

The calculation device 600 includes, for example as illustrated in FIG. 15, an image acquisition unit 610, a model calculation unit 620, a gradient calculation unit 630, a phase update unit 640, and a drive unit 650. The calculation device 600 is mounted with software for realizing functions of the calculation device 600, and the calculation device 600 realizes the functions of the calculation device 600 by executing the software.

The calculation device 600 can be implemented by a circuit including at least one semiconductor integrated circuit, such as at least one processor (for example, central processing unit (CPU)), at least one application-specific integrated circuit (ASIC), and/or at least one field programmable gate array (FPGA). At least one processor can be configured to execute all or part of the functions of the calculation device 600, by reading instructions from at least one non-transitory and tangible computer readable medium. As for these media, various forms may be used, for example but not limited to, various magnetic media such as hard disks, various optical media such as CDs and DVDs, or various semiconductor memories (i.e. semiconductor circuits) such as volatile memories or non-volatile memories. The volatile memories may include DRAMs and SRAMs. The non-volatile memories may include ROMs and NVRAMs. ASIC is an integrated circuit (IC) specialized for executing all or part of the functions of the calculation device 600. FPGA is an integrated circuit, allowing after-manufactured configuration to execute all or part of the functions of the calculation device 600.

The image acquisition unit 610 acquires the image data Da, Db from the neural network units 180, 220, and outputs the acquired image data Da, Db to the gradient calculation unit 630, as light intensity distribution data I₁.

The model calculation unit 620 generates light intensity distribution data I₂ (image data) for learning purpose, for example based on formula (1), formula (2), formula (3), and formula (4) shown in FIG. 15, and outputs the data to the gradient calculation unit 630. Each of the formula (1), formula (2), formula (3), and formula (4) is Rayleigh-Sommerfeld Formula. In the formula (1), formula (2), formula (3), and formula (4), x and y represent coordinates of each of pixels of the modulation element 181. A generation method of light intensity distribution data I₂ in the model calculation unit 620 is not limited to the above explanation. L represents loss function, and o represents phase distribution.

Here, the formula (1) is a formula for calculating intensity distribution from optical complex amplitude distribution. The formula (2) is Rayleigh-Sommerfeld Formula. The formula (3) is an auxiliary formula of the formula (2). The formula (4) is an auxiliary formula of the formula (3). Moreover, the meaning of each symbol is as below:
h (x, y, z): Integration Kernel of Rayleigh-Sommerfeld Formula;
φ: Phase distribution displayed in SLM;
λ: Wavelength of light.

The gradient calculation unit 630 derives a gradient (differential value (δL/δφ)) relative to the phase distribution of the loss function L, by inputting, for example the light intensity distribution data I₁ acquired from the image acquisition unit 610, and the light intensity distribution data I₂ acquired from the model calculation unit 620, into formula (5) of FIG. 15. The gradient calculation unit 630 outputs, for example the derived differential value (δL/δφ) to the phase update unit 640.

On the right side of the formula (5), in the item on the right side, the light intensity distribution data I₂ in the model calculation unit 620 is used as the light intensity distribution data. This is because, the question of how the minute change of phase distribution affects the actually-measured intensity distribution, is in a black box. On the right side of the formula (5), in the item on the left side, the light intensity distribution data I₁ acquired from the image acquisition unit 610 is used as the light intensity distribution data. This is because, on the right side of the formula (5), the item on the left side shows how the minute change of intensity distribution affects the loss function L, and therefore, strict calculation can be performed by using the actually-measured intensity distribution.

The phase update unit 640 updates the phase amount acquired at a preceding step, based on the differential value (δL/δφ) acquired from the gradient calculation unit 630. The phase update unit 640 updates the phase amount acquired at the precedent step, for example based on formula (6) of FIG. 15. In the formula (6), γ represents learning ratio. The phase update unit 640 outputs, for example the derived phase amount, to the drive unit 650.

The drive unit 650 outputs the phase amount of each of the modulation elements 181 included in the optical neural network 180, to the optical neural network 180 as a control signal Ctr2. Thus, the drive unit 650 sets the phase amount of each of the modulation elements 181 included in the optical neural network 180, as the phase amount acquired from the phase update unit 640.

In the present modification example, the calculation device 600 adjusts, by machine learning, the phase amount of each of the modulation elements 181 included in the optical neural network 180. Thus, for example, it is possible to perform highly accurate image reconstruction in the neural network unit 220 (or 220A), it is possible to perform highly accurate classification of characters in the neural network unit 220B, and/or it is possible to perform highly accurate determination of handwritings in the neural network unit 220C.

### Modification Example I

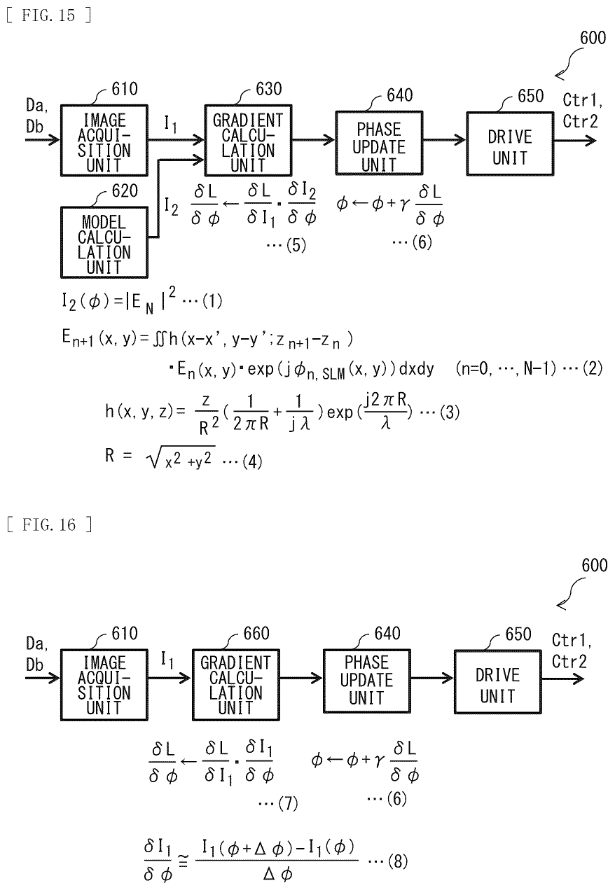

FIG. 16 illustrates a modification example of the calculation device 600 according to the modification example H described above. With reference to the above modification example H, for example as illustrated in FIG. 16, the calculation device 600 is equivalent to a device, in which, the model calculation unit 620 is omitted, and a gradient calculation unit 660 is provided instead of the gradient calculation unit 630.

In the present modification example, each of the modulation elements 181 included in the optical neural network 180 is an element, which can drive each pixel at a high speed. For example, it is assumed that each of the modulation elements 181 is composed on pixels of 500×500. In this case, where the phase amount of each pixel of each of the modulation elements 181 is changed one by one, 500×500=250,000 images can be obtained. For example, if each of the modulation elements 181 can drive each pixel at a drive frequency of 1 GHz, each of the modulation elements 181 can output 250,000 images at 0.25 ms. Thus, where each of the modulation elements 181 is the element, which can drive each pixel at a high speed, then, by minutely changing the phase amount one by one, of each pixel of each of the modulation elements 181, the gradient calculation unit 660 can directly calculate δI₁/δφ (see formula (8)).

The gradient calculation unit 660 derives a gradient (differential value (δL/δφ)) relative to the phase distribution of the loss function L, by inputting, for example the light intensity distribution data I₁ acquired from the image acquisition unit 610, into formula (7) and formula (8) of FIG. 16. The gradient calculation unit 660 outputs, for example the derived differential value (δL/δφ) to the phase update unit 640.

In the present modification example, δI₁/δφ can be obtained based on the actually-measured image. Thus, as compared with the modification example H described above, it is possible to improve performance of image reconstruction, character classification, and/or handwriting determination.

### 3. Application Example

Next, an application example of the optical calculation processing system 1 according to the above embodiment will be explained.

The technology according to the present disclosure can be applied to various products. For example, the technology according to the present disclosure may be realized as a device installed in any kind of mobile bodies, such as automobiles, electric vehicles, hybrid electric vehicles, motorcycles, bicycles, personal mobilities, aircrafts, drones, ships, robots, construction machines, agricultural machines, and/or tractors.

FIG. 17 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 17, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 17 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

FIG. 18 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 18 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 17, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 17, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 17 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for achieving each function of the optical calculation processing system 1 described with reference to FIGS. 1 to 16 and the like can be implemented in any one of the control units and the like. In addition, a computer-readable recording medium in which such a computer program is stored may be provided.

The recording medium is, for example, a magnetic disk, an optical disk, a magneto-optical disk, a flash memory, or the like. In addition, the computer program described above may be distributed, for example, through a network without using a recording medium.

In the vehicle control system 7000 explained above, the optical calculation processing system 1 explained with reference to FIG. 1 to FIG. 16 may be used, for example, as a light source steering unit of LIDAR as an environment sensor. Moreover, the image recognition in the imaging unit can be performed in an optical computing unit using the optical calculation processing system 1, which has been explained with reference to FIG. 1 to FIG. 16, etc. In a case that the optical calculation processing system 1, which has been explained with reference to FIG. 1 to FIG. 16, etc., is used as a high-efficiency, high-luminance projection device, it is possible to project lines and characters on a ground. In particular, it is possible to display lines so that people outside a vehicle can understand a passing route of the vehicle when the vehicle is in a reverse motion, and/or it is possible to display a pedestrian crossing by light, when the vehicle gives way to the pedestrian.

Moreover, at least one component of the optical calculation processing system 1, which has been explained with reference to FIG. 1 to FIG. 16, etc., may be realized in a module (for example, an integrated circuit module configured by one die) for the integrated control unit 7600 as illustrated in FIG. 17. Furthermore, the optical calculation processing system 1, which has been explained with reference to FIG. 1 to FIG. 16, etc., may be realized by a plurality of the control units of the vehicle control system 7000 as illustrated in FIG. 17.

Although the present disclosure has been described with reference to the embodiments, modification examples, and application examples, the present disclosure is not limited to the above-described embodiments and the like, and various modifications are possible. It should be noted that the effects described in this specification are only exemplified. Effects of the present disclosure are not limited to the effects described herein. The present disclosure may have effects other than the effects described herein.

For example, the present disclosure may also be configured as follows.
(1)

An optical calculation device including:
an optical neural network unit that is configured by hardware, and outputs a feature amount map as an intensity distribution by encoding entering light;
a photodetection unit that generates image data by photodetecting the feature amount map; and
an output unit that outputs the image data to an external communication network.
(2)

The optical calculation device according to (1), in which the optical neural network unit includes a plurality of phase difference elements, or a plurality of metasurfaces.
(3)

The optical calculation device according (1), in which the optical neural network unit includes a plurality of spatial light modulation liquid crystal elements, or a plurality of MEMS mirrors.
(4)

The optical calculation device according (3), further includes a control unit that changes weight of a plurality of the spatial light modulation liquid crystal elements or a plurality of the MEMS mirrors, based on input data from outside.
(5)

The optical calculation device according any one of (1) to (4), in which the photodetection unit includes an image sensor or a photodetector array.
(6)

An optical calculation processing system including an optical calculation device and an information processing device, communicatable with each other via a communication network, in which,
the optical calculation device includes:
an optical neural network unit that is configured by hardware, and outputs a feature amount map as a light intensity distribution by encoding entering light;
a photodetection unit that generates image data by photodetecting the feature amount map; and
an output unit that outputs the image data to the information processing device via the communication network,
and in which,
the information processing device includes a processing unit that processes the image data acquired from the optical calculation device via the communication network.
(7)

The optical calculation processing system according to (6), in which the optical neural network unit includes a plurality of phase difference elements, or a plurality of metasurfaces.
(8)

The optical calculation processing system according to (6), in which the optical neural network unit includes a plurality of spatial light modulation liquid crystal elements, or a plurality of MEMS mirrors.
(9)

The optical calculation processing system according to (8), further includes a control unit that changes weight of a plurality of the spatial light modulation liquid crystal elements or a plurality of the MEMS mirrors, based on input data from outside.
(10)

The optical calculation processing system according to any one of (6) to (9), in which the photodetection unit includes an image sensor or a photodetector array.
(11)

The optical calculation processing system according to any one among (6) to (10), in which the processing unit includes a neural network unit that generates reconstructed image data corresponding to the entering light by decoding the image data.
(12)

The optical calculation processing system according to (11), further including a light projection unit that generates irradiation light, and causes to generate the entering light from reflected light of the irradiation light.
(13)

The optical calculation processing system according to (12), in which the processing unit reconstructs a three-dimensional shape of an object onto which the irradiation light is irradiated, based on the reconstructed image data.
(14)

The optical calculation processing system according to (12), in which the processing unit estimates attitude or orientation of an object onto which the irradiation light is irradiated, based on the reconstructed image data.
(15)

The optical calculation processing system according to (12), in which the processing unit estimates material of an object onto which the irradiation light is irradiated, based on the reconstructed image data.
(16)

The optical calculation processing system according to (12), in which the light projection unit is configured to cause to generate a plurality of the pieces of reflected light by applying the irradiation light onto an object from a plurality of directions, and in which,
the optical calculation device includes:
a plurality of the optical neural network units, provided one by one for each of the pieces of reflected lights; and
a plurality of the photodetection units, provided one by one for each of the optical neural network units,
and in which,
the output unit outputs the image data, acquired from each of the photodetection unit, to the information processing device via the communication network.
(17)

The optical calculation processing system according to any one of (6) to (16), including at least two of:
a first neural network unit that generates reconstruction image data corresponding to the entering light by decoding the image data;
a second neural network unit that generates classifications of characters included in the entering light by decoding the image data; and
a third neural network unit that generates handwritings of characters included in the entering light by decoding the image data.
(18)

The optical calculation processing system according to any one of (6) to (17), in which the optical calculation device further includes:
an optical-address-type spatial light modulation element; and
a light source unit that applies coherent light onto the optical-address-type spatial light modulation element,
and wherein,
the optical-address-type spatial light modulation element is configured to synthesize the coherent light with the entering light by irradiation of the coherent light.
(19)

The optical calculation processing system according to any one of (6) to (18), in which the optical neural network unit includes a plurality of phase difference elements configured by birefringent material.
(20)

The optical calculation processing system according to (6), further including a calculation device that derives a differential value serving as a gradient relative to phase distribution of loss function, based on the image data acquired in the photodetection unit and image data acquired by model calculation, and updates phase amount to be outputted to the optical neural network unit, based on the derived differential value.
(21)

The optical calculation processing system according to (6), in which the processing unit includes a neural network unit that generates reconstructed image data corresponding to the entering light by decoding the image data,
and further including a calculation device that derives a differential value serving as a gradient relative to phase distribution of loss function, based on the reconstructed image data and image data acquired by model calculation, and updates phase amount to be outputted to the optical neural network unit, based on the derived differential value.
(22)

The optical calculation processing system according to (6), further including a calculation device that derives a differential value serving as a gradient relative to phase distribution of loss function, based on the image data acquired in the photodetection unit, and updates phase amount to be outputted to the optical neural network unit, based on the derived differential value.
(23)

The optical calculation processing system according to (6), in which the processing unit includes a neural network unit that generates reconstructed image data corresponding to the entering light by decoding the image data,
and further including a calculation device that derives a differential value serving as a gradient relative to phase distribution of loss function, based on the reconstructed image data, and updates phase amount to be outputted to the optical neural network unit, based on the derived differential value.

The present application claims the benefit of Japanese Priority Patent Application JP2022-119067 filed with the Japan Patent Office on Jul. 26, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An optical calculation device comprising:
an optical neural network unit that is configured by hardware, and outputs a feature amount map as an intensity distribution by encoding entering light;
a photodetection unit that generates image data by photodetecting the feature amount map; and
an output unit that outputs the image data to an external communication network.

2. The optical calculation device according to claim 1, wherein the optical neural network unit includes a plurality of phase difference elements, or a plurality of metasurfaces.

3. The optical calculation device according to claim 1, wherein the optical neural network unit includes a plurality of spatial light modulation liquid crystal elements, or a plurality of MEMS mirrors.

4. The optical calculation device according to claim 3, further includes a control unit that changes weight of a plurality of the spatial light modulation liquid crystal elements or a plurality of the MEMS mirrors, based on input data from outside.

5. The optical calculation device according to claim 1, wherein the photodetection unit includes an image sensor or a photodetector array.

6. An optical calculation processing system comprising an optical calculation device and an information processing device, communicatable with each other via a communication network, wherein,
the optical calculation device includes:
an optical neural network unit that is configured by hardware, and outputs a feature amount map as a light intensity distribution by encoding entering light;
a photodetection unit that generates image data by photodetecting the feature amount map; and
an output unit that outputs the image data to the information processing device via the communication network,
and wherein,
the information processing device includes a processing unit that processes the image data acquired from the optical calculation device via the communication network.

7. The optical calculation processing system according to claim 6, wherein the optical neural network unit includes a plurality of phase difference elements, or a plurality of metasurfaces.

8. The optical calculation processing system according to claim 6, wherein the optical neural network unit includes a plurality of spatial light modulation liquid crystal elements, or a plurality of MEMS mirrors.

9. The optical calculation processing system according to claim 8, further includes a control unit that changes weight of a plurality of the spatial light modulation liquid crystal elements or a plurality of the MEMS mirrors, based on input data from outside.

10. The optical calculation processing system according to claim 6, wherein the photodetection unit includes an image sensor or a photodetector array.

11. The optical calculation processing system according to claim 6, wherein the processing unit includes a neural network unit that generates reconstructed image data corresponding to the entering light by decoding the image data.

12. The optical calculation processing system according to claim 11, further comprising a light projection unit that generates irradiation light, and causes to generate the entering light from reflected light of the irradiation light.

13. The optical calculation processing system according to claim 12, wherein the processing unit reconstructs a three-dimensional shape of an object onto which the irradiation light is irradiated, based on the reconstructed image data.

14. The optical calculation processing system according to claim 12, wherein the processing unit estimates attitude or orientation of an object onto which the irradiation light is irradiated, based on the reconstructed image data.

15. The optical calculation processing system according to claim 12, wherein the processing unit estimates material of an object onto which the irradiation light is irradiated, based on the reconstructed image data.

16. The optical calculation processing system according to claim 12, wherein the light projection unit is configured to cause to generate a plurality of the pieces of reflected light by applying the irradiation light onto an object from a plurality of directions, wherein,
the optical calculation device includes:
a plurality of the optical neural network units, provided one by one for each of the pieces of reflected lights; and
a plurality of the photodetection units, provided one by one for each of the optical neural network units,
and wherein,
the output unit outputs the image data, acquired from each of the photodetection unit, to the information processing device via the communication network.

17. The optical calculation processing system according to claim 6, including at least two of:
a first neural network unit that generates reconstruction image data corresponding to the entering light by decoding the image data;
a second neural network unit that generates classifications of characters included in the entering light by decoding the image data; and
a third neural network unit that generates handwritings of characters included in the entering light by decoding the image data.

18. The optical calculation processing system according to claim 6, wherein the optical calculation device further includes:
an optical-address-type spatial light modulation element; and
a light source unit that applies coherent light onto the optical-address-type spatial light modulation element,
and wherein,
the optical-address-type spatial light modulation element is configured to synthesize the coherent light with the entering light by irradiation of the coherent light.

19. The optical calculation processing system according to claim 6, wherein the optical neural network unit includes a plurality of phase difference elements configured by birefringent material.

20. The optical calculation processing system according to claim 6, further comprising a calculation device that derives a differential value serving as a gradient relative to phase distribution of loss function, based on the image data acquired in the photodetection unit and image data acquired by model calculation, and updates phase amount to be outputted to the optical neural network unit, based on the derived differential value.

21. The optical calculation processing system according to claim 6, wherein the processing unit includes a neural network unit that generates reconstructed image data corresponding to the entering light by decoding the image data,
and further comprising a calculation device that derives a differential value serving as a gradient relative to phase distribution of loss function, based on the reconstructed image data and image data acquired by model calculation, and updates phase amount to be outputted to the optical neural network unit, based on the derived differential value.

22. The optical calculation processing system according to claim 6, further comprising a calculation device that derives a differential value serving as a gradient relative to phase distribution of loss function, based on the image data acquired in the photodetection unit, and updates phase amount to be outputted to the optical neural network unit, based on the derived differential value.

23. The optical calculation processing system according to claim 6, wherein the processing unit includes a neural network unit that generates reconstructed image data corresponding to the entering light by decoding the image data,
and further comprising a calculation device that derives a differential value serving as a gradient relative to phase distribution of loss function, based on the reconstructed image data, and updates phase amount to be outputted to the optical neural network unit, based on the derived differential value.
